(19) United States
(12) Patent Application Publication
(10) Pub. No.: US 2026/0249594 A1
(43) Pub. Date: Aug. 27, 2026

(54) COMPOSTABLE FILM FOR PACKAGING FLUIDS

(71) Applicant: AMCOR FLEXIBLES NORTH AMERICA, INC., Neenah, WI (US)

(72) Inventor: Gabriela I. BURGOS SOLÓRANZO, Plano, TX (US)

(21) Appl. No.: 18/875,838

(22) PCT Filed: Jun. 30, 2022
(86) PCT No.: PCT/US2022/035790

§ 371 Date: Dec. 17, 2024

(51) Int. Cl. B32B 27/08; B32B 27/30; B32B 27/36; B32B 37/12; B32B 37/15; B32B 38/00

(52) U.S. Cl. CPC B32B 27/08; B32B 27/306; B32B 27/36; B32B 37/12; B32B 37/15; B32B 38/145; B32B 2250/03; B32B 2250/24; B32B 2255/10; B32B 2255/205; B32B 2307/7163; B32B 2307/7244; B32B 2307/7246; B32B 2307/7376; B32B 2329/00; B32B 2367/00; B32B 2439/40; B32B 2439/70; B32B 2439/80

(57) ABSTRACT

A compostable multilayer film is described as well as hermetically packaged products using said compostable multilayer film. The compostable multilayer films include a first film located on a first exterior surface (i.e., exterior of the package) the first film being selected from a PLA film, a paper, and a starch based film; a second film located on a second exterior surface (i.e., the interior of the package, contacting the product) the second film comprising a blend of PLA and PBAT; and a barrier film located between the first film and the second film, the barrier film including a base film having PLA and a vapor deposited metal layer located on the surface of the base film. The compostable multilayer film may be suitable for extended shelf-life storage of fluid products.

### TECHNICAL FIELD

This disclosure is related to compostable multilayer films that are suitable for packaging fluid products that require hermetic protection from moisture loss.

### BACKGROUND

It has become increasingly desirable to design flexible packaging structures that are more sustainable. Increased sustainability may be in the form of using raw materials that are renewably resourced, such as paper or starch-based polymers. Increased sustainability may also be in the form of an end-of-life solution that is something other than waste, such as reusable or recyclable options. For flexible packaging that is used for extended shelf-life food products, it can be difficult to match the required performance properties to any of these more sustainable options.

In addition to the packaging design challenges, flexible packages that hold moisture-rich food products may be very difficult to recycle given that there is typically food remnants in the package. If the food packages are small, the size of the packages also make them difficult to recycle and become potential pollutants for recycling streams (typically glass or paper). These applications become candidates for compostable solutions. Typically, these packages require shelf-life from 3 to 18 months. If compostable, the packaging should be able to fulfill well established compostable standards that require disintegration, biodegradation at industrial and home composting conditions (12 weeks at 58° C. or 26 weeks at 21° C., respectively) and that fulfill chemical characterization and ecotoxicity requirements.

High moisture transmission rates of compostable materials have traditionally limited their use in flexible packaging to applications with low or non-moisture barrier requirements or for rigid applications where short shelf-life is required. Examples of applications that use compostable materials are single use rigid food service containers and utensils that will be disposed of within a few hours or days of use.

The packaging industry has had difficulty designing compostable packaging films for long term hermetic storage of fluid (i.e., liquid) product, particularly those that are acidic or oily products. These products are particularly degrading to most compostable materials, causing loss of barrier and appearance properties in a matter of days.

The challenge becomes to provide a durable enough solution that resists the presence of fluid liquid, oily or acidic products and that delivers the product protection for liquid applications but that also should accomplish short times to compost according to well-known composting standards.

### SUMMARY

The developments described herein include multilayer structures that can expand the applicability of compostable materials to packages for fluid applications requiring extended shelf-life. In various embodiments, the solutions presented here provide for 1) the desired functionality for product protection preventing moisture loss and product oxidation, 2) the prevention of barrier deterioration, delamination, or chemical attack of the package during the product shelf-life and/or 3) the enablement of biodegrading and disintegrating under industrial or home composting conditions. The compostable multilayer film may be particularly suitable for use in packaged products, enabling extended shelf-life storage of fluid products.

Disclosed herein are compostable multilayer films having a first film located on a first surface of the compostable multilayer film, the first film selected from the group consisting of a polylactic acid (PLA) film, a paper, and a starch-based film, a second film located on a second surface of the compostable multilayer film, the second film comprising a blend of polylactic acid (PLA) polymer and poly(butylene adipate-co-terephthalate) (PBAT) polymer, and a barrier film located between the first film and the second film, the barrier film comprising a base film comprising PLA polymer and a vapor deposited metal layer located on a surface of the base film.

Some embodiments of the compostable multilayer film further include a first adhesive layer and a second adhesive layer, the first adhesive layer located between the first film and the barrier film, and the second adhesive layer located between the second film and the barrier film. Each of the first adhesive layer and the second adhesive layer may be made of a compostable adhesive material.

The base film of the barrier film may have a first layer comprising PLA polymer, a second layer comprising PBAT polymer and a third layer comprising butenediol vinyl alcohol (BVOH) polymer. The vapor deposited metal layer may be deposited on a surface of the base film comprising the third layer or the vapor deposited metal layer may be deposited on a surface of the base film comprising the first layer.

Certain embodiments of the compostable multilayer film have the vapor deposited metal layer deposited on a surface of the base film, the surface comprising PLA polymer.

Specific embodiments of the compostable multilayer film include a first film having a first skin layer comprising PLA polymer, a second skin layer comprising PLA polymer, and a core layer comprising PBAT polymer. In other embodiments, the first film is a PLA film or a starch-based film.

The compostable multilayer film may be free from paper and cellulose.

Some compostable multilayer films may include a printed indicia layer located on a surface of the first film.

Some embodiments of the compostable multilayer film include a first film of a PLA film, located on a first surface of the compostable multilayer film, a printed indicia layer located on a surface of the first film opposing the first surface of the compostable multilayer film, a second film located on a second surface of the compostable multilayer film, the second film comprising a blend of PLA polymer and PBAT polymer, a barrier film located between the first film and the second film, the barrier film comprising a base film comprising PLA polymer and a vapor deposited metal layer located on a surface of the base film, a first adhesive layer comprising a compostable adhesive material, the first adhesive layer located between the first film and the barrier film, and a second adhesive layer comprising a compostable adhesive material, the second adhesive layer located between the second film and the barrier film. The base film of the barrier film may include a first layer comprising PLA polymer, a second layer comprising PBAT polymer and a third layer comprising BVOH polymer.

Other embodiments of the compostable multilayer film include a first film located on a first surface of the compostable multilayer film, the first film being one of a PLA film, a paper, and a starch based film, a printed indicia layer located on a surface of the first film, a second film located on a second surface of the compostable multilayer film, the second film comprising a blend of PLA polymer and PBAT polymer, and a barrier film located between the first film and the second film, the barrier film comprising a base film and a vapor deposited metal layer, the base film comprising a first layer comprising PLA polymer, a second layer comprising PBAT polymer, a third layer comprising BVOH polymer, a fourth layer comprising PBAT polymer and a fifth layer comprising PLA polymer, the layers of the base film arranged in an order of first layer/second layer/third layer/fourth layer/fifth layer, and the vapor deposited metal layer located on the first layer of the base film. The compostable multilayer films may further include a sixth layer located between the second layer and the third layer, and a seventh layer located between the third layer and the fourth layer, each of the sixth layer and the seventh layer comprising a compostable tie material. The compostable multilayer film may have a first film including a first skin layer comprising PLA polymer, a second skin layer comprising PLA polymer, and a core layer comprising PBAT polymer.

Also disclosed herein are packaged products including a package made of an embodiment of the compostable multilayer film and a product. The product may be a fluid. The fluid product may have a pH less than 4. The package may essentially consist of or consists of one or more embodiments of compostable multilayer films. The package may be hermetically sealed.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of an embodiment of a compostable multilayer film;

FIG. 2 is a cross-sectional view of another embodiment of a compostable multilayer film;

FIG. 3 is a cross-sectional view of an embodiment of a first film;

FIG. 4 is a cross-sectional view of an embodiment of a barrier film;

FIG. 5 is a cross-sectional view of another embodiment of a barrier film;

FIG. 6 is a cross-sectional view of another embodiment of a barrier film;

FIG. 7A is a front view of an embodiment of a packaged product;

FIG. 7B is a cross-sectional view of the packaged product shown in FIG. 7A; and

FIG. 8 is a perspective view of another embodiment of a packaged product.

The drawings show some but not all embodiments. The elements depicted in the drawings are illustrative and not necessarily to scale, and the same (or similar) reference numbers denote the same (or similar) features throughout the drawings.

### DETAILED DESCRIPTION

There is a need for a compostable multilayer film that can be used for long-term packaging of fluid (i.e., liquid) products. Previous attempts resulted in films which rapidly lose barrier properties and otherwise prematurely degrade. The solutions presented here provide for 1) the desired functionality for product protection preventing moisture loss and product oxidation over the shelf-life time period, 2) the prevention of barrier deterioration, delamination, or chemical attack of the package during the shelf-life time period and 3) the enablement of biodegrading and disintegrating under industrial or home composting conditions and fulfilling chemical characterization and ecotoxicity requirements. The solution is particularly desirable for packages which typically have some food product remaining affixed to the package after a consumer dispenses the product, rendering them undesirable for a recycling process.

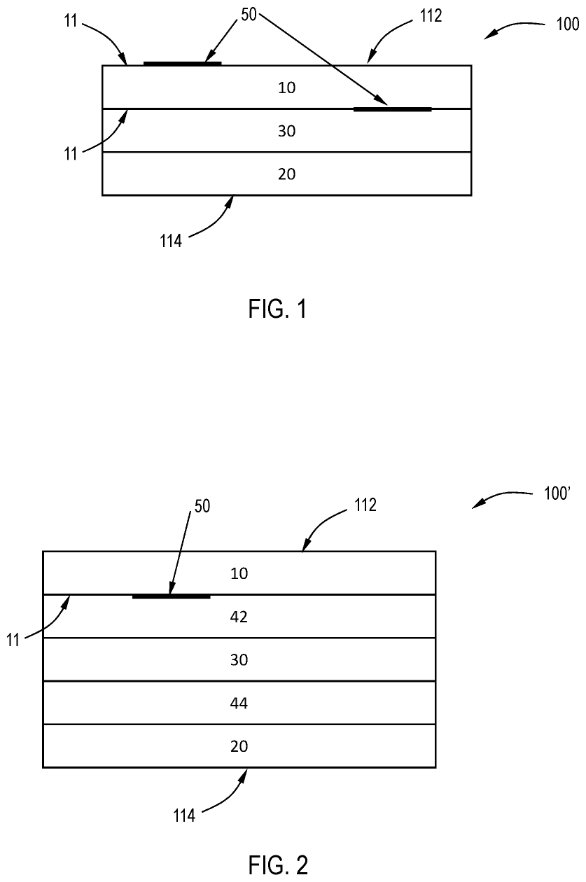

The compostable multilayer films disclosed herein include a first film, a second film and a barrier film, as will be detailed and discussed below. A first embodiment of a compostable multilayer film 100 is shown in FIG. 1, wherein the first film 10 is located at a first surface 112 of the multilayer compostable film 100, the second film 20 is located at a second surface 114 of the multilayer compostable film 100 and the barrier film 30 is located between the first film 10 and the second film 20. Also shown in FIG. 1 is optional printed indicia layers 50 which may be present on either or both surfaces 11 of the first film 10.

Another embodiment of a compostable multilayer film 100′ is shown in FIG. 2. As in FIG. 1, the first film 10 is located at a first surface 112 of the multilayer compostable film 100′, the second film 20 is located at a second surface 114 of the multilayer compostable film 100′ and the barrier film 30 is located between the first film 10 and the second film 20. The embodiment of FIG. 2 further includes a first adhesive layer 42 which connects the first film 10 and the barrier film 30, and a second adhesive layer 44 which connects the second film 20 and the barrier film 30. Again, FIG. 2 shows an optional printed indicia layer 50, this time only on the surface 11 of the first film 10 that is opposing the first surface 112 of the compostable film 100′ (i.e., on the internally facing surface 11).

As used herein, the term “compostable” refers to materials such as polymers, layers, films or packages are able to disintegrate and biodegrade at industrial and home composting conditions (12 weeks at 58° C. or 26 weeks at 21° C., respectively) and fulfill industrial compostable standards such as EN 13432-2000, ASTM D6400 “Standard Specification for Labeling of Plastics Designed to be Aerobically Composted in Municipal or Industrial Facilities” or ASTM D6868 “Standard Specification for Labeling of End Items that Incorporate Plastics and Polymers as Coatings or Additives with Paper and Other Substrates Designed to be Aerobically Composted in Municipal or Industrial Facilities”, and home compostable standards such as AS-5810-2010 NF T51800, among others.

Embodiments of the compostable multilayer film may have one, both or neither of the first adhesive layer and the second adhesive layer, as shown in FIG. 2. The term “adhesive layer,” or “tie layer,” refers to a layer or material placed on one or more layers or films to promote the adhesion of that layer or film to another surface. For example, tie layers may be positioned between two layers of a multilayer film to maintain the two layers in position relative to each other and prevent undesirable delamination. In another example, adhesive layers may be positioned between two films of a laminate to maintain the two layers in position relative to each other and prevent undesirable delamination. As used herein, layers or films that are “in direct contact with” or “are directly adjacent to” each other have no intervening material between them.

Some embodiments of the compostable multilayer film have one or more adhesive layers that are made of a compostable adhesive applied by an adhesive lamination process. Commercially available compostable adhesives may be solvent-based, solvent-free or water-based. Commercially available adhesives may have base reactive chemistry of isocyanate. Alternatively, the films and layers of the compostable multilayer film may be connected to one another by other means such as extrusion lamination, using an extruded polymer for bonding, coextrusion or thermal lamination.

In some embodiments, each of the layers and films of the compostable are strongly bonded to each other. In one or more embodiments, bond strength between each film is greater than or equal to 200 g/in.

The term “layer”, as used herein, refers to a building block of a film or laminate that is a structure of a single material type, a homogeneous blend of materials or a dispersion blend of materials. A layer may be a single polymer, a blend of materials within a single polymer type or a blend of various polymers, may contain metallic materials and may have additives. Layers may be continuous with the film (i.e., coextensive with the film) or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major layer surfaces. In other words, one major surface of an exterior layer is exposed. An interior layer is one that is connected to another layer at both major surfaces. In other words, an interior layer is between two other layers. A layer may have sub-layers.

Similarly, the term “film”, as used herein, refers to a web built of layers and/or films, all of which are directly adjacent to and connected to each other. A film can be described as having a thickness that is insignificant as compared to the length and width of the film. Films are generally regarded as having two major surfaces, opposite each other, expanding in the length and width directions. As used herein, a “laminate” is a film that may be built from an unlimited number of films and/or layers, the films and/or layers being bonded together by any known process such as, but not limited to, coextrusion, coating or laminating, to form a composite article.

As used herein, the term “exterior layer”, “exterior film”, “skin layer”, “surface layer” or “surface film” is used to describe a film or layer that is located on one of the major surfaces of the film or laminate in which it is comprised. As used herein, the term “interior layer” or “interior film” is used to describe a film or layer that is not located on the surface of the film in which it is comprised. An interior film or layer is adjacent to another film or layer on both sides.

As shown in FIGS. 1 and 2, these embodiments and other embodiments of compostable multilayer films may include printed indicia layers (i.e., ink layers, graphics layers, print layers). Printed indicia may be applied to one or both surfaces of one or more films of the compostable multilayer films. The printed indicia layer may be applied by any printing process, such as but not limited to flexographic printing, rotogravure printing, or digital printing. The printed indicia layers may be inks that are compostable. The printed indicia layer may be coextensive with the compostable multilayer film (100% coverage) or may be patterned. The printed indicia layer may include multiple colors that are layered upon each other. If the printed indicia layer is located on an exterior surface of the compostable multilayer film, the printed indicia layer may include a clear over lacquer having the function of heat resistance and/or scuff protection. The printed indicia layer may only consist of a heat resistant over lacquer.

The compostable multilayer films disclosed herein are able fulfill industrial compostable standards such as EN 13432-2000, ASTM D6400 “Standard Specification for Labeling of Plastics Designed to be Aerobically Composted in Municipal or Industrial Facilities” or ASTM D6868 “Standard Specification for Labeling of End Items that Incorporate Plastics and Polymers as Coatings or Additives with Paper and Other Substrates Designed to be Aerobically Composted in Municipal or Industrial Facilities”, and home compostable standards such as AS-5810-2010 NF T51800, among others.

In some embodiments of the compostable multilayer film, each layer except the vapor deposited metal layer of the barrier film (further described below) contains a compostable material. In some embodiments each layer of the compostable multilayer film, except the vapor deposited metal layer of the barrier film, consists of compostable materials.

Some embodiments of the compostable multilayer film may include additional films and/or layers. For example, the compostable multilayer film may contain a thin primer layer. The compostable multilayer film may include other functional layers such as tie layers or moisture barrier layers. Additional layers should be minimized such that they do not disrupt the mechanical performance and/or composting performance of the film.

### First Film

The first film is a heat resistant and compostable film. The first film may serve as a printable web, able to carry the printed indicia if required for the packaging application. In some embodiments, the first film may be a paper. In some embodiments, the first film may be made out of polybutylene succinate (PBS) polymer, polyhydroxyalkanoates (PHAs), Cellulose, Cellulose Acetate or other starch-based materials (such as potato starch). Other embodiments of the first film are PLA films, or films that contain one or more PLA layers. A PLA layer of a PLA film may contain greater than 50% PLA polymer, greater than 75% PLA polymer or greater than 95% PLA polymer, by weight. In some embodiments, the compostable multilayer film is free from paper and cellulose and the first film is a PLA film.

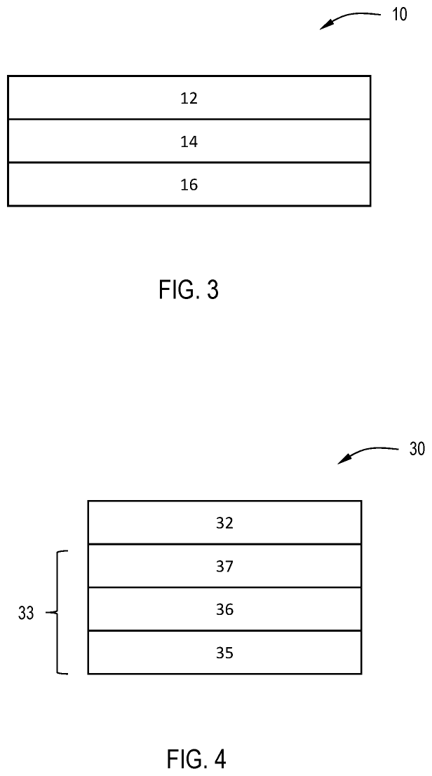

One embodiment of a first film 10 is shown in FIG. 3. Shown here, the first film 10 has three layers and may comprise a structure of PLA/PBAT/PLA. The first film 10 has a first skin layer 12, a core layer 14 and a second skin layer 16. As shown, the first skin layer 12 is located at a surface of the first film 10 and the second skin layer 16 is located at the opposite surface of the first film 10. The core layer 14 is located between the first skin layer 12 and the second skin layer 16. The core layer 14 may be in direct contact with each of the first skin layer 12 and the second skin layer 16 or there may be intervening layers such as tie layers. The first skin layer 12 may contain PLA polymer or may consist of PLA polymer. The second skin layer 16 may contain PLA polymer or may consist of PLA polymer. The core layer 14 may contain PBAT polymer or may consist of PBAT polymer. Some embodiments of a first film that is a PLA film may have a thickness of 1 to 1.5 mils. A first film, such as the embodiment shown in FIG. 3, may be produced by a coextrusion process, such as blown film or cast film may be either oriented by a formal orientation process or not oriented.

As used herein, “skin layer” refers to a layer of a film that is necessarily located at the surface of the film. By this definition, a film has two skin layers and all other layers that may be present within the film are between the skin layers. If a film is a monolayer film, that single layer is a skin layer, occupying both surfaces of the film.

As used herein, “PLA polymer” or “PLA” is a compostable polymer based on polylactic acid. Commercial examples of PLA polymers are available from Total Corbion and NatureWorks. A layer of a film that comprises PLA may include at least 50%, at least 75% or at least 95% PLA polymer, by weight.

As used herein, “PBAT polymer” or “PBAT” is a compostable biopolymer based on poly(butylene adipate-co-terephthalate). Commercial examples of PBAT biopolymers are available from many suppliers, including but not limited to Mitsubishi, Novamont, Jiangsu Torise Biomaterials Co., and BASF. A layer of a film that comprises PBAT polymer may include at least 50%, at least 75% or at least 95% PBAT polymer, by weight.

### Barrier Film

The barrier film provides moisture and/or oxygen barrier properties to the compostable multilayer film. The barrier film includes a base film upon which a metal layer is deposited. The base film is monolayer or multilayer, containing at least one PLA layer. The PLA layer may contain greater than 50% PLA polymer, greater than 75% PLA polymer or greater than 95% PLA polymer, by weight. The base film may be produced by a coextrusion process, such as blown film, and is preferably not oriented by a formal orientation process. The base film is compostable. Some embodiments of the barrier film may have a thickness of 1-2 mils.

The metal layer is deposited onto the base film by a vacuum metalization process. In some embodiments, the metal layer has been produced by two passes through a vacuum metalizing process. Typically, the vapor deposited metal layer is an aluminum metal or an alloy thereof. The thickness of the metal layer is between about 3.5 and 100 nm. The metal layer may be deposited onto the PLA layer (i.e., the metal is in direct contact with the PLA layer) of the base film. Alternatively, the metal layer may be deposited onto another layer of the base film. The metal layer is deposited onto a surface of the base film and the metal layer is continuous with the base film and the compostable multilayer film.

The barrier film may have an optical density in a range from 1.0 to 3.0. The barrier film may exhibit an oxygen gas transmission rate (OTR) of between 0 to 0.02 cm³/100 in²/24 hours at 73° F. or 0 to 0.2 cm³/100 in²/24 hours at 73° F. or 0 to 0.5 cm³/100 in²/24 hours at 73° F. at 73° F. and 0% Rh when tested in accordance with ASTM D 3985. The barrier film may exhibit a water vapor transmission rate (WVTR) of between 0 to 0.006 g/100 in²/24 hours or 0 to 0.03 g/100 in²/24 hours or 0 to 0.08 g/100 in²/24 hours or 0 to 0.2 g/100 in²/24 hours at 100° F. and 90% Rh when tested in accordance with ASTM F 1249.

An embodiment of a barrier film 30 is shown in FIG. 4. The barrier film 30 includes a vapor deposited metal layer 32 on the surface of a base film 33. The base film 33 includes a first layer 35 comprising PLA polymer, a second layer 36 comprising PBAT polymer and a third layer 37 comprising of a copolymer that may be butenediol vinyl alcohol (BVOH). As in this embodiment, some embodiments of the barrier film may include a metal layer deposited on the surface of a layer containing butenediol vinyl alcohol. In other embodiments, the metal layer may be deposited on the surface of the layer containing PLA polymer (i.e., metal layer 32 on the surface of the first layer 35).

As used herein, “BVOH polymer” or “BVOH” is a compostable butenediol vinyl alcohol copolymer such as Nichigo G-Polymer™ grades available from Soarus. A layer of a film that comprises BVOH polymer may include at least 50%, at least 75% or at least 95% BVOH polymer, by weight.

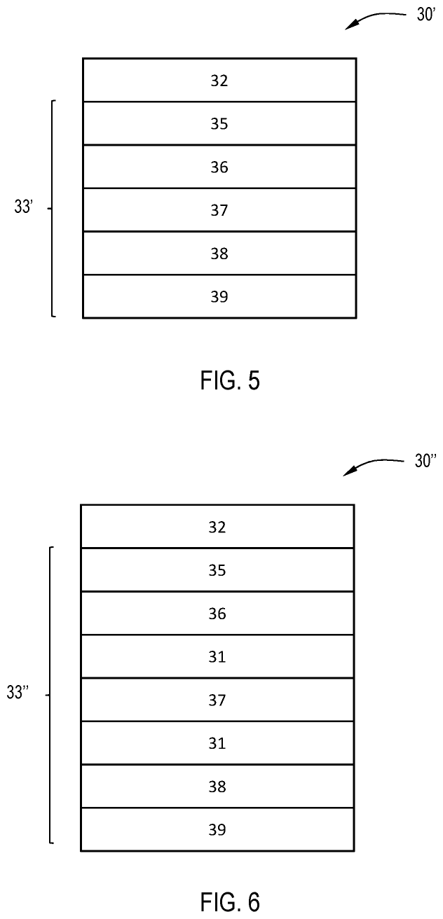

Another embodiment of a barrier film 30′ is shown in FIG. 5. The barrier film 30′ again includes a vapor deposited metal layer 32 on the surface of a base film 33′. The base film 33′ includes a first layer 35 comprising PLA polymer, a second layer 36 comprising PBAT polymer, a third layer 37 comprising BVOH, a fourth layer 38 comprising PBAT polymer and a fifth layer 39 comprising PLA polymer or PBAT polymer. Another embodiment of a barrier film 30″ is shown in FIG. 6. Barrier film 30″ is similar to barrier film 30′ but includes base film 33″ which further includes two tie layers 31, located between the second layer 36 and the third layer 37 and between the third layer 37 and the fourth layer 38. The tie layers 31 each include a compostable tie material. As used herein, a “compostable tie material” is a polymeric based material that enhances the bond between the two layers it intersects and is compostable. In each of the embodiments shown in FIGS. 5 and 6, the vapor deposited metal layer 32 is located on the first layer 35 of the base film 33′,33″.

### Second Film

The second film is a monolayer or multilayer film having properties to provide sealing for package forming. At least one layer of the second film includes a blend of PLA polymer and PBAT polymer and may contain fillers up to 49% of the total film and slip agents. The layer containing the PLA/PBAT blend may be the sealing layer. The second film may be a single layer comprising the PLA/PBAT blend that may contain 40 to 60% PBAT polymer, by weight. The thickness of the second film may be 0.8 to 2 mils.

The second film is located on the second surface of the compostable multilayer film, as shown in FIG. 1. The second film includes a surface layer which becomes a surface layer of the compostable multilayer film and can form heat seals to itself or other packaging components. The second film may be entirely constructed from compostable materials.

The second film may serve as protection of the barrier film against migrating moisture and other chemical species.

In some embodiments, the second film is formed by an extrusion process, such as blown film or cast film extrusion, and is adhesively laminated to the barrier film (see FIG. 2).

In some embodiments, the second film is incorporated into the base film of the barrier film. For example, the compostable multilayer film 100 shown in FIG. 1 may include a first film 10 and a barrier film 30 such as the barrier film 30 shown in FIG. 4. The first layer 35 of the base film 33 may include a blend of PLA polymer and PBAT polymer and may serve as the second film 20 and no additional layers are added to the compostable multilayer film 100. In this instance, the base film 33 of the barrier film 30 would only include the second layer 36 and the third layer 37.

### Packaged Product

The term “package” is used herein to describe an article that may house an object (i.e., a product), the article formed by bonding one or more compostable multilayer films or other packaging components to itself or each other around a periphery, thus forming a package interior space. A “packaged product” refers to the one or more packaging components forming a hermetically sealed package and the product therein. As used herein, hermeticity refers to a seal or sealed package that is completely closed and essentially airtight. Hermetically sealed packages generally have a need for storage and package integrity over a period that is greater than a few days. Package integrity includes a consistent appearance, maintenance of barrier properties, maintenance of lamination bonds, and maintenance of seals.

The product may be any type of food, beverage, pharmaceutical or other medical aid, nutraceutical, consumer good or industrial good. The product may be fluid in nature. Examples of products include, but are not limited to, condiments such as ketchup, mustard, mayonnaise, or relish, pudding, yogurt, cheese sauce, nut butter, jam/jelly, dairy or non-dairy creamer, guacamole, applesauce, pureed baby food, baby formula, nutritional drinks/shakes, beverage or supplement concentrates, cough syrup, fish oil, lotion, salve/ointment, personal care items, soap/detergent, or solvent.

As mentioned, the product may be fluid in nature, or may have a fluid component. The product may be water-based (i.e., has water as a medium or main ingredient) or oil-based (i.e., has oil as a medium or main ingredient). The compostable multilayer film described herein may be particularly useful in containing an acidic product for a significant shelf-life (days, weeks or months) with minimal loss of barrier. The product may have a pH below 7, below 6, below 5, below 4 or even below 3.

The packaged products disclosed herein include a package formed from at least one compostable multilayer film and optionally other components. In some embodiments of the packaged product, the entire package is formed from a single compostable multilayer film that has been folded over and sealed to itself (i.e., a flow wrap or stick pack configuration). In some embodiments of the packaged product, a compostable multilayer film is sealed to another compostable multilayer film (i.e., a sachet configuration). In some embodiments of the packaged product, a compostable multilayer film is a lidding component which is sealed to a formed container such as a cup or tray. Packages that include components that are not according to the compostable multilayer films disclosed herein may also be compostable, such that the entire package is compostable. In some embodiments, the package includes components that are not compostable but can be separated from the portions that are compostable for proper disposal.

In each of the packaged products, the first surface of the compostable multilayer film is facing away from the product, exposed to the outside environment, and the second surface of the compostable multilayer film is facing toward the product, exposed to the product and the internal environment.

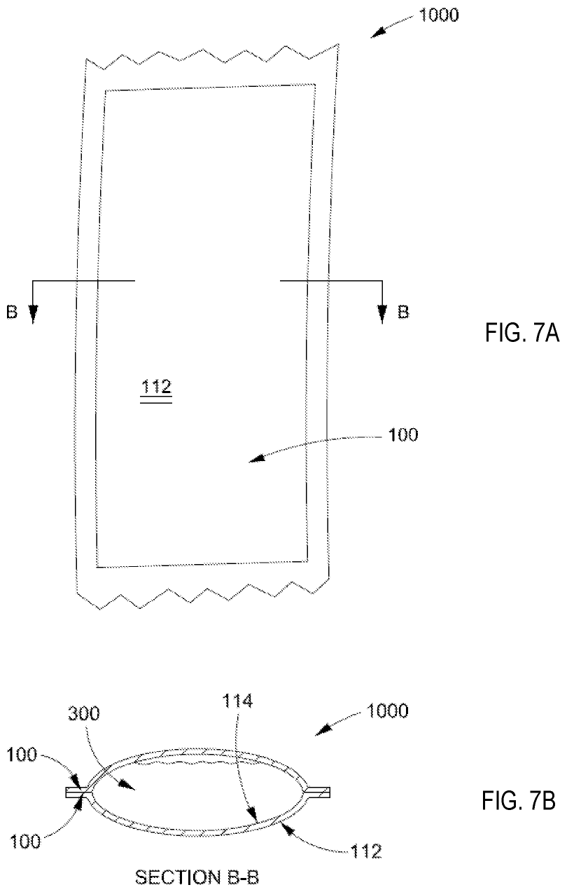

One embodiment of a packaged product 1000 is demonstrated in FIGS. 7A and 7B. FIG. 7A shows a front view of a sachet style package wherein a compostable multilayer film 100 on the front is sealed to another compostable multilayer film (not shown in FIG. 7A) on the back. The films are hermetically sealed to each other at the perimeter and the product is stored in the unsealed area between the films, internal to the seals. FIG. 7B shows a cross-section of the packaged product 1000 taken at section B-B. Now shown are both compostable multilayer films 100, sealed at the edges. The compostable multilayer films 100 each have the first surface 112 facing the outside environment and the second surface 114 facing the product 300. As shown in this embodiment, the second surface 114 may be in contact with the product 300. The internal space within the hermetically sealed package may be entirely filled with product 300 or may be only partially filled with product 300 as shown in FIG. 7B.

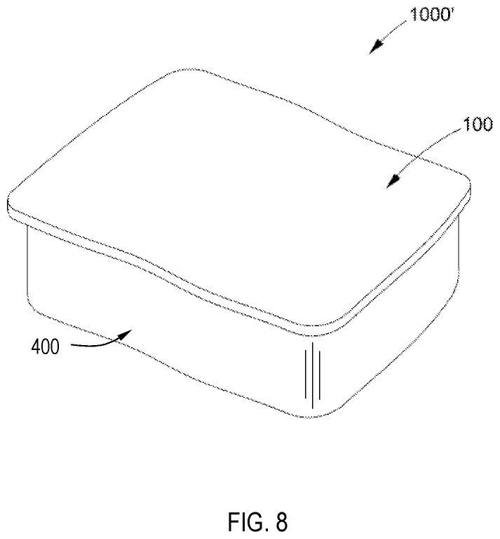

Another embodiment of a packaged product 1000′ is shown in FIG. 8. This figure is a perspective view of a configuration formed package component 400 sealed to a lid of a compostable multilayer film 100. As noted, the formed package component 400 may also be compostable, making the entire package compostable.

The package of the packaged product may be designed for various options to enable opening. For example, in FIG. 8, the compostable multilayer film 100 may be configured so that a consumer can peel it away from the formed package component 400 to access the product. A peelable seal may have a seal strength between 400 g/in and 2,500 g/in, according to ASTM F88. Other packaged products may include very strong seals (seal strength greater than 2,500 g/in) and access to the product may be achieved by cutting or tearing the package components. For example, the packaged product 1000 shown in FIGS. 7A and 7B may include seal strengths that cannot be manually separated and access to the product may be gained by tearing the compostable multilayer film 100 from the edge of the package, through the perimeter seal, breaking the hermiticity of the package. It may be advantageous to have strong peel strengths to avoid premature opening or leaking of the package during storage and distribution of the packaged product.

The packaged products disclosed herein advantageously include a compostable package and/or a compostable multilayer film which may allow the product to have a shelf-life of up to one week, up to two weeks, up to one month, up to two months, up to three months, up to 4 months, up to 5 months, up to 6 months, up to 7 months, up to 8 months, up to 9 months, up to 10 months, up to 11 months or up to 12 months. The shelf-life is dependent upon one or more variables including: the product packaged, the storage conditions of the packaged product and the barrier of the packaging components. The compostable multilayer films disclosed have the surprising combination of compostability and maintenance of the barrier over the shelf-life of the product. As used herein, the shelf-life of a packaged product is the time period in which the product maintains quality (i.e., taste and appearance) acceptable for consumer use. The shelf-life may be determined due to degradation of product color, taste or suitability for consumption (i.e., microbial growth).

In some embodiments, the packaged product is refrigerated during storage and distribution (i.e., during the packaged product shelf-life). In other embodiments, the packaged product may be stored at non-refrigerated or room temperature conditions. It has been found that refrigerated storage of the packaged product may assist in prolonging the time frame in which the compostable multilayer film can maintain high barrier, thus lengthening the shelf-life of the packaged product.

The compostable multilayer films disclosed herein are particularly useful for packaged product which have a small size, such as 6″ by 9″, 5″ by 7″, 5″ by 5″, 3″ by 3″, 3″ by 2″, etc., as these types of packages are difficult to collect and/or sort for recycling. Small packages and small packaging components may be better suited to compostable end-of-life solutions, as opposed to recycling.

The compostable multilayer films disclosed herein are particularly useful for packaged product formats and/or product types which result in significant product residue remaining in the package after consumer use. The packaged product may be of a style or configuration that inhibits/prohibits complete removal of the product. The packaged product may be of a style or configuration that inhibits/prohibits cleaning the package after use. The product packaged may be one that tends to cling or adhere to the package. In these cases, the package should not be recycled because the product residue contaminates the recycling process. In these cases, composting is an excellent solution as the product residue may promote the decomposition process.

### Examples and Data

Films were produced having structures according to Table 1. These are adhesive laminations of the structure [first film/adhesive/barrier film/adhesive/second film]. These films were adhesive laminated using a solvent-free adhesive. For each barrier film, a notation (m) is made to show which way the vapor deposited metal layer of the barrier film was facing. Each film component (i.e., A1, B1, etc.) are according to:

A1=38.1 micron blown film (non-oriented) having the structure PLA/PBAT/PLA. PLA was a polylactic acid polymer having a density of 1.24 g/cm³, and PBAT was a poly(butylene adipate-co-terephthalate) polymer having a density of 1.26 g/cm³.

B1=38 micron metalized blown film (non-oriented) having the structure metal/BVOH/PBAT/PLA. PLA was a polylactic acid polymer having a density of 1.24 g/cm³, and PBAT was a poly(butylene adipate-co-terephthalate) polymer having a density of 1.26 g/cm³. BVOH was a butenediol vinyl alcohol copolymer having a melt flow rate of 2.5 g/10 min (210° C./2.16 kg). The film was vacuum metalized using aluminum.

B2=30.5 micron metalized PLA film, EarthFirst® grade MUL available from PSI™.

B3=38 micron metalized blown film (non-oriented) having the structure metal/PLA/PBAT/BVOH/PBAT/PLA. PLA was a polylactic acid polymer having a density of 1.24 g/cm³, and PBAT was a poly(butylene adipate-co-terephthalate) polymer having a density of 1.26 g/cm³. BVOH was a butenediol vinyl alcohol copolymer having a melt flow rate of 2.5 g/10 min (210° C./2.16 kg). The film was metalized.

C1=50 micron blown film having a blend of PLA and PBAT.

C2=20.3 micron blown film having a blend of PLA and PBAT.

TABLE 1
Structures and Components of Example Films

| | | | Second Film |
|---|---|---|---|
| | | | (Second |
| | First Film (First | Barrier | Exterior |
| Example | Exterior surface) | Film | Surface) |
| E1 | A1 | (m) B1 | C1 |
| E2 | A1 | (m) B2 | C1 |
| E3 | A1 | B1 (m) | C1 |
| E4 | A1 | (m) B3 | C2 |
| E5 | A1 | B3 (m) | C2 |
| E6 | A1 | (m) B1 | C2 |
| E7 | A1 | B1 (m) | C2 |
| E8 | A1 | (m) B2 | C2 |

Comparative films were produced having the structures according to Table 2. These are adhesive laminations of the structure [first film/adhesive/barrier film/adhesive/second film]. If there is no first film or second film listed, the structure was a 2-ply lamination.

TABLE 2
Structures and Components of Comparative Example Films

| | | | Second Film |
|---|---|---|---|
| | First Film | | (Second |
| | (First Exterior | | Exterior |
| Example | surface) | Barrier Film | Surface) |
| CE1 | — | Metalized | PHA |
| | | cellophane | |
| CE2 | — | PVdC coated | PBS |
| | | cellophane | |
| CE3 | — | Metalized | PBS |
| | | cellophane | |
| CE4 | — | PVdC coated | PBAT |
| | | cellophane | |
| CE5 | — | Metalized | PLA |
| | | cellophane | |
| CE6 | — | PVdC coated | PLA |
| | | cellophane | |
| CE7 | A1 | (m) B3 | — |
| CE8 | A1 | (m) B1 | — |

The MVTR of Example films E2 through E8 and Comparative Example films CE7 and CE8 were tested according to ASTM F1249 at conditions of 100° F./90% RH. Results are shown in Table 3.

TABLE 3
MVTR results for Example films E2-E8 and Comparative Example
Films CE7 and CE8; ASTM F1249 100° F./90% RH variable tested

| | MVTR |
|---|---|
| Example | [g/m²/day] |
| E2 | 4.85 |
| E3 | 1.245 |
| E4 | 0.817 |
| E5 | 1.615 |
| E6 | 3.295 |
| E7 | 1.42 |
| E8 | 1.805 |
| CE7 | 4.945 |
| CE8 | 2.92 |

The MVTR analysis shows the importance of the synergy of the barrier film and the second film for maintaining good barrier. Comparative Example film CE7 is the same as Example film E4 with the exception that CE7 does not have a second film. In this case, we see that the difference in the measured MVTR is significant (4.945 for CE7 and 0.817 for E4).

A shelf-life test was completed using Comparative Example Films CE1 through CE6. Small pouches were formed using the film, sealing the second exterior surface to itself. The pouches were filled with ketchup or mustard and stored at accelerated testing conditions of 100° F./20% RH. The testing was halted at two weeks due to the poor appearance of the films-all metalized films experienced loss of metal due to degradation from the product and sample CE4 showed severe delamination due to tunneling between the layers. Additionally, the moisture loss from these packages was extremely high, as shown in Table 4. These films did not have sufficient moisture barrier properties nor product blocking capability.

For comparison, same shelf-life test was completed for each of the films Example 1 through Example 8. The pouches maintained an excellent appearance through at least 7 months of testing, without any signs of metal corrosion, tunneling or delamination. As a result of the superior condition of the film, the barrier was maintained, and moisture loss was found to be significantly less, as is shown by the data in Table 4 for films E1 and E2.

The oxygen barrier of the films was evaluated by way of monitoring oxidation of the product (ketchup). Again, small packets were made using the film, and ketchup was placed inside. The packets were stored at accelerated testing conditions of 100° F./20% RH for approximately 10 weeks. The color of the product was measured, and the a/b value is an indicator of the amount of color change and thus product oxidation. Specifically for ketchup, the a/b value is reportedly linear with the lycopene content and is typically used to evaluated oxidation of (i.e., loss of) this component. Fresh ketchup typically has an a/b value above 1.9. For this testing, the product had an initial a/b value of about 1.75.

TABLE 4
Moisture Loss and Color Measurement for Comparative
Example Films CE1 through CE6 and Example Films E1
and E2; Moisture Loss measured by weight loss as a
ratio of initial product weight, packets filled with
ketchup or mustard, stored at 100° F./20% RH;
average value reported for each film variable tested

| | Moisture Loss by Weight % | | | | |
|---|---|---|---|---|---|
| | 15 | 29 | 45 | 60 | a/b |
| Example | days | days | days | days | Value |
| CE1 | 22.7 | n/a | n/a | n/a | n/a |
| CE2 | 26.1 | n/a | n/a | n/a | n/a |
| CE3 | 40 | n/a | n/a | n/a | n/a |
| CE4 | 37.1 | n/a | n/a | n/a | 3.1/4.2/2.8 |
| CE5 | 36.8 | n/a | n/a | n/a | n/a |
| CE6 | 21.5 | n/a | n/a | n/a | n/a |
| E1 | 3.9 | 9.2 | 18.7 | 28.3 | 1.5/1.7/1.8 |
| E2 | 3.3 | 6.8 | 12.9 | 19.8 | 1.5/1.5/1.6 |

Although moisture loss of Variables E1 and E2 was significant at 60 days, package integrity was encouraging. Packages stored at accelerated conditions and monitored for any potential package integrity damage, did not experience deterioration at these harsh condition for more than 7 months.

Findings from this work, demonstrate how the selection, composition and combination of compostable films can impact the final barrier results of the package. Studies conducted at accelerated conditions (100 F/20% RH) of compostable materials have shown that there is a rough equivalence to 3-5× shelf life at standard conditions; therefore, the results shown here at 60 days in accelerated conditions might represent 180-300+ days at standard conditions. Results also show the potential use for these materials on fluid product packaging applications that may include oily, acidic or other product ingredients. The study also shows that it is possible to provide oxygen and moisture barrier at various levels and they can be adjusted through different compositions and combination of films. These findings open the possibility for more sustainable solutions for small format packages that contain fluids and that today are very challenging to recycle.

### Compostable Multilayer Film Embodiments

Embodiment A. A compostable multilayer film comprising:
a first film located on a first surface of the compostable multilayer film, the first film selected from the group consisting of a PLA film, a paper, and a starch based film;
a second film located on a second surface of the compostable multilayer film, the second film comprising a blend of PLA and PBAT; and
a barrier film located between the first film and the second film, the barrier film comprising a base film comprising PLA and a vapor deposited metal layer located on a surface of the base film.

Embodiment B. The compostable multilayer film according to Embodiment A further comprising a first adhesive layer and a second adhesive layer, the first adhesive layer located between the first film and the barrier film and the second adhesive layer located between the second film and the barrier film, and each of the first adhesive layer and the second adhesive layer comprise a compostable adhesive material.

Embodiment C. The compostable multilayer film according to Embodiment A or B wherein the base film of the barrier film comprises a first layer comprising PLA, a second layer comprising PBAT and a third layer comprising BVOH.

Embodiment D. The compostable multilayer film according to Embodiment C wherein the vapor deposited metal layer is deposited on a surface of the base film comprising the third layer.

Embodiment E. The compostable multilayer film according to Embodiment C wherein the vapor deposited metal layer is deposited on a surface of the base film comprising the first layer.

Embodiment F. The compostable multilayer film according to Embodiment A or B wherein the vapor deposited metal layer is deposited on a surface of the base film, the surface comprising PLA.

Embodiment G. The compostable multilayer film according to any of Embodiments A through F, the first film comprising:
a first skin layer comprising PLA,
a second skin layer comprising PLA, and
a core layer comprising PBAT.

Embodiment H. The compostable multilayer film according to any of Embodiments A through F wherein the first film is a PLA film or a starch based film.

Embodiment I. The compostable multilayer film according to any of Embodiments A through H wherein the multilayer film is free from paper and cellulose.

Embodiment J. The compostable multilayer film according to any of Embodiment A through I further comprising a printed indicia layer located on a surface of the first film.

Embodiment K. A compostable multilayer film comprising:
a first film located on a first surface of the compostable multilayer film, the first film is a PLA film;
a printed indicia layer located on a surface of the first film opposing the first surface of the compostable multilayer film;
a second film located on a second surface of the compostable multilayer film, the second film comprising a blend of PLA and PBAT;
a barrier film located between the first film and the second film, the barrier film comprising a base film comprising PLA and a vapor deposited metal layer located on a surface of the base film;
a first adhesive layer comprising a compostable adhesive material, the first adhesive layer located between the first film and the barrier film; and
a second adhesive layer comprising a compostable adhesive material, the second adhesive layer located between the second film and the barrier film.

Embodiment L. The compostable multilayer film according to Embodiment K wherein the base film of the barrier film comprises a first layer comprising PLA, a second layer comprising PBAT and a third layer comprising BVOH.

Embodiment M. A compostable multilayer film comprising:
a first film located on a first surface of the compostable multilayer film,
the first film is one of a PLA film, a paper, and a starch based film;
a printed indicia layer located on a surface of the first film;
a second film located on a second surface of the compostable multilayer film, the second film comprising a blend of PLA and PBAT; and
a barrier film located between the first film and the second film, the barrier film comprising a base film and a vapor deposited metal layer, the base film comprising a first layer comprising PLA, a second layer comprising PBAT, a third layer comprising BVOH, a fourth layer comprising PBAT and a fifth layer comprising PLA, the layers of the base film arranged in an order of first layer/second layer/third layer/fourth layer/fifth layer, and the vapor deposited metal layer located on the first layer of the base film.

Embodiment N. The compostable multilayer film according to Embodiment M wherein the base film further includes a sixth layer located between the second layer and the third layer, and a seventh layer located between the third layer and the fourth layer, each of the sixth layer and the seventh layer comprising a compostable tie material.

Embodiment O. The compostable multilayer film according to claim Embodiment M or N wherein the first film comprises:
a first skin layer comprising PLA,
a second skin layer comprising PLA, and
a core layer comprising PBAT.

### Packaged Product Embodiments

Embodiment P. A packaged product comprising a package comprising the compostable multilayer film according to any Compostable Multilayer Film Embodiment and a product.

Embodiment Q. The packaged product according to Embodiment P wherein the product is a fluid.

Embodiment R. The packaged product according to Embodiment Q wherein the fluid product has a pH less than 4.

Embodiment S. The packaged product according to any of Embodiments P, Q or R wherein the package consists of one or more compostable multilayer films.

Embodiment T. The packaged product according to any of Embodiments P through S wherein the package is hermetically sealed.

1. A compostable multilayer film comprising:
a first film located on a first surface of the compostable multilayer film, the first film selected from the group consisting of a polylactic acid (PLA) film, a paper, and a starch-based film;
a second film located on a second surface of the compostable multilayer film, the second film comprising a blend of PLA and poly(butylene adipate-co-terephthalate) (PBAT); and
a barrier film located between the first film and the second film, the barrier film comprising a base film comprising PLA and a vapor deposited metal layer located on a surface of the base film.

2. The compostable multilayer film according to claim 1, further comprising a first adhesive layer and a second adhesive layer, the first adhesive layer located between the first film and the barrier film and the second adhesive layer located between the second film and the barrier film, and each of the first adhesive layer and the second adhesive layer comprise a compostable adhesive material.

3. The compostable multilayer film according to claim 1, wherein the base film of the barrier film comprises a first layer comprising PLA, a second layer comprising PBAT and a third layer comprising butenediol vinyl alcohol (BVOH).

4. The compostable multilayer film according to claim 3, wherein the vapor deposited metal layer is deposited on a surface of the base film comprising the third layer.

5. The compostable multilayer film according to claim 3, wherein the vapor deposited metal layer is deposited on a surface of the base film comprising the first layer.

6. The compostable multilayer film according to claim 1, wherein the vapor deposited metal layer is deposited on a surface of the base film, the surface comprising PLA.

7. The compostable multilayer film according to claim 1, the first film comprising:
a first skin layer comprising PLA,
a second skin layer comprising PLA, and
a core layer comprising PBAT.

8. The compostable multilayer film according to claim 1, wherein the first film is a PLA film or a starch-based film.

9. The compostable multilayer film according to claim 1, wherein the multilayer film is free from paper and cellulose.

10. The compostable multilayer film according to claim 1, further comprising a printed indicia layer located on a surface of the first film.

11. A compostable multilayer film comprising:
a first film located on a first surface of the compostable multilayer film, the first film is a PLA film;
a printed indicia layer located on a surface of the first film opposing the first surface of the compostable multilayer film;
a second film located on a second surface of the compostable multilayer film, the second film comprising a blend of PLA and PBAT;
a barrier film located between the first film and the second film, the barrier film comprising a base film comprising PLA and a vapor deposited metal layer located on a surface of the base film;
a first adhesive layer comprising a compostable adhesive material, the first adhesive layer located between the first film and the barrier film; and
a second adhesive layer comprising a compostable adhesive material, the second adhesive layer located between the second film and the barrier film.

12. The compostable multilayer film according to claim 11, wherein the base film of the barrier film comprises a first layer comprising PLA, a second layer comprising PBAT and a third layer comprising BVOH.

13. A compostable multilayer film comprising:
a first film located on a first surface of the compostable multilayer film, the first film is one of a PLA film, a paper, and a starch based film;
a printed indicia layer located on a surface of the first film;
a second film located on a second surface of the compostable multilayer film, the second film comprising a blend of PLA and PBAT; and
a barrier film located between the first film and the second film, the barrier film comprising a base film and a vapor deposited metal layer, the base film comprising a first layer comprising PLA, a second layer comprising PBAT, a third layer comprising BVOH, a fourth layer comprising PBAT and a fifth layer comprising PLA, the layers of the base film arranged in an order of first layer/second layer/third layer/fourth layer/fifth layer, and the vapor deposited metal layer located on the first layer of the base film.

14. The compostable multilayer film according to claim 13, wherein the base film further includes a sixth layer located between the second layer and the third layer, and a seventh layer located between the third layer and the fourth layer, each of the sixth layer and the seventh layer comprising a compostable tie material.

15. The compostable multilayer film according to claim 13, wherein the first film comprises:
a first skin layer comprising PLA,
a second skin layer comprising PLA, and
a core layer comprising PBAT.

16. A packaged product comprising a package comprising the compostable multilayer film according to claim 1 and a product contained within the package.

17. The packaged product according to claim 16, wherein the product is a fluid.

18. The packaged product according to claim 17, wherein the fluid product has a pH less than 4.

19. The packaged product according to claim 16, wherein the package consists of one or more compostable multilayer films.

20. The packaged product according to claim 16, wherein the package is hermetically sealed.
